(19) United States
(12) Patent Application Publication
(10) Pub. No.: US 2005/0207926 A1
(43) Pub. Date: Sep. 22, 2005

(54) Scroll compressor

(75) Inventors: Fumitoshi Nishiwaki, Nishinomiya-shi (JP); Hiroshi Hasegawa, Toyonaka-shi (JP); Atsuo Okaichi, Hirakata-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: Matsushita Electric Industrial Co., Ltd., Kadoma-shi (JP)

(21) Appl. No.: 11/087,730

(22) Filed: Mar. 24, 2005

Related U.S. Application Data
(63) Continuation of application No. PCT/JP03/11996, filed on Sep. 19, 2003.

(30) Foreign Application Priority Data
Sep. 24, 2002 (JP) 2002-277002

(51) Int. Cl. F01C 1/02; F04C 18/00; F03C 4/00; F01C 1/063

(52) U.S. Cl. 418/55.2

(57) ABSTRACT

A scroll compressor comprises a compression mechanism 4, a main shaft 5 for driving the compression mechanism 4, a motor 7 for rotating the main shaft 5, and a journal bearing 20 for supporting the main shaft 5, the journal bearing 20 is provided at its end with an annular groove 21, thereby forming an annular portion 22 on an inner peripheral side of the annular groove 21, a ratio of a groove depth of the annular groove 21 to a diameter of the main shaft 5 is in a range of 0.15 to 0.34, and a ratio of a thickness of the annular portion 22 to the diameter of the main shaft 5 is in a range of 0.09 to 0.19, with this configuration, it is possible to provide the efficient scroll compressor with a simple structure in which even when the main shaft 5 is bent or deformed by a radial force of a compression load, damage such as wearing and seizing of the journal bearing which pivotally supports the main shaft 5 is prevented, and performance is not deteriorated in a wide operation range.

### TECHNICAL FIELD

The present invention relates to a compressor for refrigerant used in a refrigerator-freezer, an air conditioner and the like, and more particularly, to a journal bearing of a scroll compressor.

### BACKGROUND TECHNIQUE

In the case of electric compressors of refrigeration air conditioning purpose, there are reciprocating type compressing portion, rotary type compressing portion and scroll type compressing portion. Any of the compressing portions of these types are used in domestic or business purpose refrigeration air conditioning fields. In any of the compressors of these types, a radial force of a main shaft which drives a compression mechanism is mainly supported by a journal bearing. Here, a conventional technique will be explained based on a scroll compressor.

FIG. 7 is a vertical sectional view of a conventional scroll compressor (see Japanese Patent Application Laid-open No. H5-79476 for example). In a container 1, a main housing 8 is provided at its upper portion with a compression mechanism 4 and at its lower portion with a motor 7. In the compression mechanism 4, a fixed scroll 2a and an orbiting scroll 2b are meshed with each other to constitute a compression chamber 3. A main shaft 5 transmits a driving force of the motor 7 to the compression mechanism 4. A main journal bearing 6 is formed in a main housing 8. The main shaft 5 is pivotally supported by the main journal bearing 6. An Oldham ring 9 restrains rotation of the orbiting scroll 2b, and a thrust bearing 10 supports a thrust load applied to the orbiting scroll 2b. An eccentric journal bearing 11 is formed in a boss 2c of the orbiting scroll 2b. An eccentric shaft portion 5a of an end of the main shaft 5 is rotatably inserted into the eccentric journal bearing 11. The orbiting scroll 2b revolves with respect to the fixed scroll 2a by rotation of the main shaft 5. A rotor 7a of the motor 7 is mounted on a main shaft portion 5b of the main shaft 5. A stator 7b of the motor 7 is fixed to the container 1 by shrinkage fit. The motor 7 is provided at its lower portion with an auxiliary housing 12, and an auxiliary journal bearing 13 is formed in the auxiliary housing 12. A suction pipe 14 introduces a refrigerant into the container 1, and a discharge pipe 15 discharges a high-pressure refrigerant to outside. The container 1 is provided at its bottom with an oil reservoir 17 for storing lubricant oil 16. High pressure gas on the compression side is applied in the container 1. The main shaft 5 has a through hole 18 through which lubricant oil 16 is supplied to the main journal bearing 6, the eccentric journal bearing 11, the thrust bearing 10 and various sliding surfaces. The lubricant oil 16 is pumped up from the lower end of the main shaft 5.

Next, the operation of the conventional scroll compressor shown in FIG. 7 will be explained.

A rotation force of the motor 7 comprising the rotor 7a and the stator 7b is transmitted to the orbiting scroll 2b by the main shaft 5 which is fixed to the rotor 7a by shrinkage fit through the eccentric shaft portion 5a. The orbiting scroll 2b revolves in a circle orbit by the Oldham ring 9 which is a rotation-preventing mechanism, the capacity of the compression chamber 3 formed between the fixed scroll 2a and the orbiting scroll 2b Is varied, and a refrigerant is compressed.

The refrigerant flows into the container 1 from an outside refrigeration cycle by through the suction pipe 14, and is compressed in the compression chamber 3 and then, pressure of the refrigerant is increased and the refrigerant flows out into the outside refrigeration cycle from the discharge pipe 15. The lubricant oil 16 stored in the bottom of the container 1 is pumped up utilizing a centrifugal force or the like caused by rotation of the main shaft 5 and the lubricant oil 16 is allowed to flow through the through hole 18 formed in a center of the main shaft 5, and the lubricant oil 16 is supplied for lubricating the bearings and for sealing the compression chamber.

In this scroll compressor, since the compression mechanism 4 projects in the axial direction from the main journal bearing 6, a radial force caused by compression load or the like is applied to the eccentric shaft portion 5a of the main shaft 5. Therefore, the main shaft 5 is of cantilever structure with respect to the main journal bearing 6 and the auxiliary journal bearing 13, and the main shaft 5 is largely bent and deformed. Therefore, eccentric contact phenomenon is generated in the ends of the main journal bearing 6 and the auxiliary journal bearing 13. Especially, the greatest load is applied to the main journal bearing 6 which is closest to a position to which a radial force is applied, and serious eccentric contact phenomenon is generated in the end of the main journal beating 6 on the side of the compression mechanism 4.

Thus, the load distribution of the journal bearing of the scroll compressor is not even in its axial direction, and there is a tendency that the load becomes extremely high on the side of the end of the journal bearing. As a result, the end portion of the journal bearing comes into direct contact with the main shaft 5, and surfaces of these portions are prone to be damaged or worn. Further, slide loss and friction are increased, the efficiency of the compressor is deteriorated and its reliability is deteriorated.

The present invention has been achieved to solve such conventional problems, and it is an object of the invention to provide an efficient scroll compressor having a simple structure in which even when a main shaft is bent or deformed by a force of compression load in its radial direction, damage of a journal bearing such as wear and seizing is prevented from being generated so that performance of the scroll compressor is not deteriorated.

### DISCLOSURE OF THE INVENTION

A first aspect of the present invention provides a scroll compressor comprising a compression mechanism, a main shaft for driving the compression mechanism, a motor for rotating the main shaft, and a journal bearing for supporting the main shaft, wherein the journal bearing is provided at its end with an annular groove, thereby forming an annular portion on an inner peripheral side of the annular groove, a ratio of a groove depth of the annular groove to a diameter of the main shaft is in a range of 0.15 to 0.34, and a ratio of a thickness of the annular portion to the diameter of the main shaft is in a range of 0.09 to 0.19.

According to a second aspect of the invention, in the scroll compressor of the first aspect, an outer peripheral surface of the annular groove is an inner peripheral surface of a recess formed in a main housing formed with the journal bearing.

According to a third aspect of the invention, in the scroll compressor of the first aspect, a surface of the main shaft in the vicinity of an end portion of the journal bearing is subjected to conversion treatment including at least sulphonitriding treatment or phosphating treatment.

According to a fourth aspect of the invention, in the scroll compressor of the first aspect, carbon dioxide refrigerant is used as working fluid to be compressed by the compression mechanism, polyalkylene glycol (PAG) oil is used as refrigeration oil for lubricating the compression mechanism and the journal bearing.

### BRIEF DESCRIPTION OF THE DRAWINGS

FIG. 1 is a vertical sectional view of a scroll compressor according to a first embodiment of the present invention;

FIG. 2 is a sectional view of a main journal bearing for the scroll compressor in the vicinity of an annular groove according to the first embodiment of the invention;

FIG. 3 is a graph of a result of an analysis showing a relation between the maximum contact pressure on an inner surface of the main journal bearing for the scroll compressor and a groove depth d of the annular groove according to the first embodiment of the invention;

FIG. 4 is a graph of a result of an analysis showing a relation between the maximum contact pressure on the inner surface of the main journal bearing for the scroll compressor and a groove thickness t of the annular groove according to the first embodiment of the invention;

FIG. 5 is a graph of a result of an analysis showing a relation between the maximum contact pressure on an inner surface of the main journal bearing for the scroll compressor and a groove depth d of the annular groove according to the first embodiment of the invention using a groove width w as a parameter;

FIG. 6 is a vertical sectional view of a scroll compressor according to a second embodiment of the invention; and

FIG. 7 is a vertical sectional view of a conventional scroll compressor.

### BEST MODE FOR CARRYING OUT THE INVENTION

Several embodiments of the present invention will be explained with reference to the drawings.

### First Embodiment

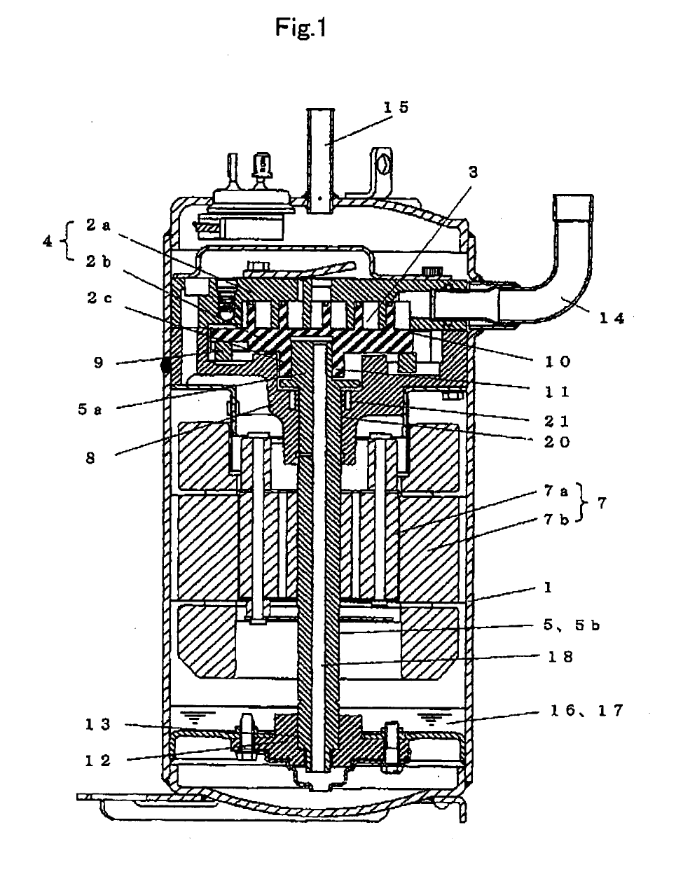

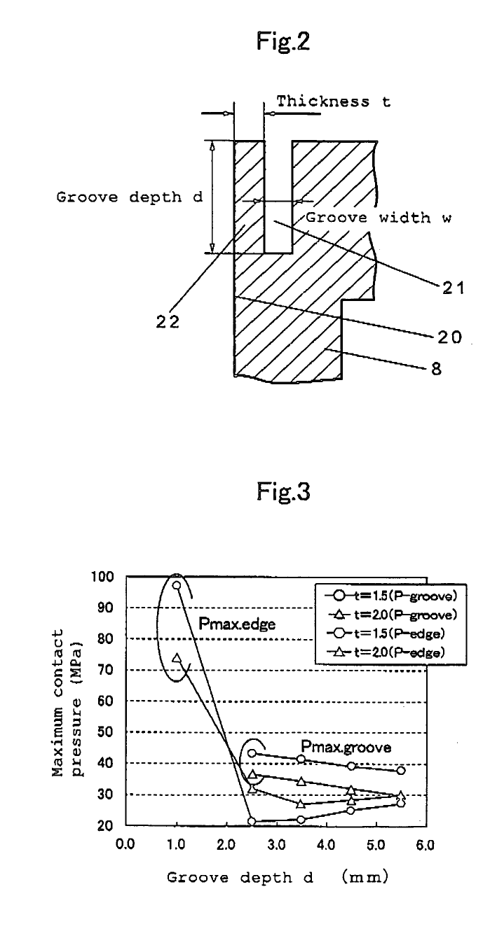

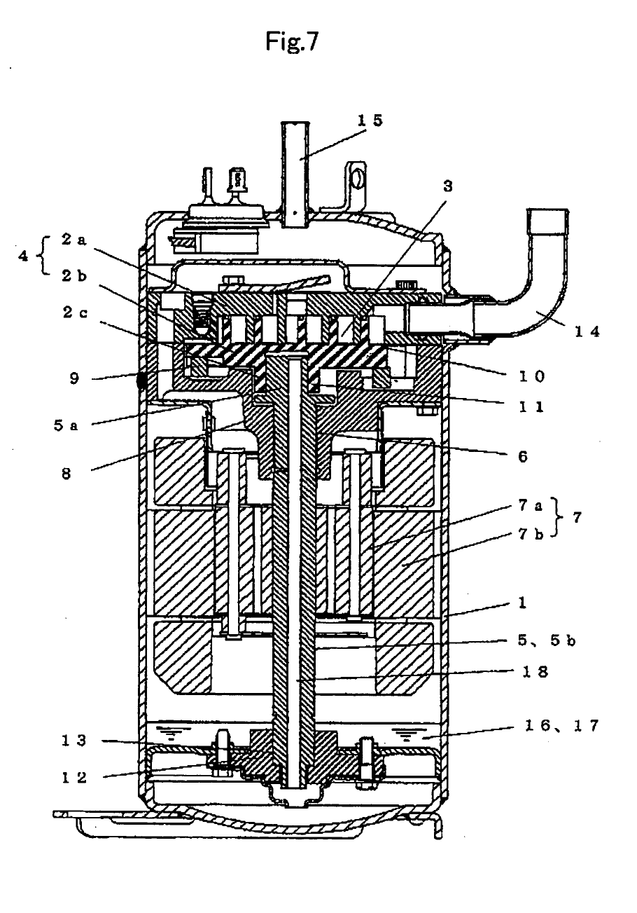

FIG. 1 is a vertical sectional view of a scroll compressor according to a first embodiment of the present invention, and FIG. 2 is a sectional view of a main journal bearing for the scroll compressor in the vicinity of an annular groove according to the first embodiment of the invention. Here, the scroll compressor shown in FIG. 1 has the same structure as the conventional scroll compressor explained with reference to FIG. 7 except a journal bearing and therefore, the same function parts are designated with the same numerals and explanation thereof is partially omitted.

In FIG. 1, an orbiting scroll 2b includes a boss 2c, and the boss 2c is formed at its central portion with an eccentric journal bearing 11. A main shaft 5 is provided at its end with an eccentric shaft portion 5a. The eccentric shaft portion 5a is inserted into the eccentric journal bearing 11. A main housing 8 is formed with a main journal bearing 20, and an auxiliary housing 12 is formed with an auxiliary journal bearing 13. The main shaft 5 is supported by the main journal bearing 20 and the auxiliary journal bearing 13, and a rotation force of a motor 7 is transmitted to the orbiting scroll 2b.

In this embodiment, as shown especially in FIG. 2, an end of the main journal bearing 20 that is opposite from the motor 7 is provided with an annular groove 21. An annular portion 22 is formed by the annular groove 21 between the main shaft 5 and the annular groove 21. When a diameter of the main shaft 5 is 16 mm, it is suitable that a groove depth d of the annular groove 21 is 2.5 mm to 5.5 mm, a groove width w of the annular groove 21 is 0.5 mm to 2.0 mm, and a thickness t of the annular portion 22 is 1.5 mm to 3.0 mm.

The main housing 8 and the auxiliary housing 12 are made of cast iron FC250, and inner surfaces of the main journal bearing 20 formed in a central portion of the main housing 8 and the auxiliary journal bearing 13 formed in a central portion of the auxiliary housing 12 are finished to about Ra 0.2. Similarly, the orbiting scroll 2b is made of aluminum alloy, and an inner surface of the eccentric journal bearing 11 formed in a central portion of the boss 2c of the orbiting scroll 2b is finished to about Ra 0.2. The main shaft 5 is made of SCM415 steel, and a surface of the main shaft 5 is subjected to sulphonitriding treatment.

Next, the operation of the compressor will be explained.

A refrigerant is compressed by the orbiting motion of the orbiting scroll 2b in the compression chamber 3 formed by a fixed scroll 2a and the orbiting scroll 2b. At that time, of the compression loads of the refrigerant, a force in the thrust direction acting in the axial direction is applied to the orbiting scroll 2b. If an intermediate pressure is applied to a lower surface of a mirror plate of the orbiting scroll 2b against the force in the thrust direction, the orbiting scroll 2b is supported by a thrust bearing 10 provided between the fixed scroll 2a and an upper surface of the mirror plate of the orbiting scroll 2b. Of the compression loads of the refrigerant, a force in the radial direction is applied to the eccentric shaft portion 5a of the main shaft 5. The main shaft 5 is supported by the main journal bearing 20 and the auxiliary journal bearing 13 of the auxiliary housing 12. If the main shaft 5 receives the cantilever compression load in the radial direction in this manner, a moment is generated, and a bending deformation determined by the load and rigidity of the shaft is generated. As a result, since the main shaft 5 is supported such that the main shaft 5 is inclined with respect to a surface of the main journal bearing 20 and a surface of the auxiliary journal bearing 13, the greatest load is applied to the main journal bearing 20 which is closest to a position to which a radial force is applied. In this embodiment, however, the annular groove 21 is formed in an upper end of the main journal bearing 20 where a bearing distance between the main shaft 5 and an inner surface of the bearing becomes extremely small (or these members directly come into contact), and the rigidity of the end of the journal bearing is reduced and thus, a moment is applied to the main shaft 5, the main shaft 5 is inclined in the bearing, and when the load distribution becomes great at the bearing end, the inner surface of the bearing end is deformed, and the contact stress between the main shaft 5 and the inner surface of the bearing can be reduced.

The present inventors used a structure analysis and found that there existed the optimal range of the shape of the annular groove 21. This range will be explained in detail.

FIGS. 3 to 5 show analysis results of a contact pressure distribution of the main shaft 5 and the inner surface of the main journal bearing 20 when a structure analysis model of specification of scroll compressor in which the annular groove 21 is formed in the upper end of the main journal bearing 20 and a cantilever compression load in the radial direction is applied to the main shaft 5.

FIG. 3 shows a relation between the groove depth d of the annular groove 21 and the maximum contact pressure of the main shaft 5 and the inner surface of the main journal bearing 20. There, Pmax.edge represents the maximum contact pressure at the tip end of the annular groove 21, and Pmax.groove represents the maximum contact pressure in the vicinity of the groove bottom of the annular groove 21. As the groove depth d is increased from a state of 0 mm (e.g., there is no annular groove), the maximum contact pressure Pmax.edge at the tip end of the annular groove 21 (i.e., bearing end) is abruptly reduced, the Pmax.edge becomes an extremely small value in a range of 2.5 mm to 5.5 mm, and if the Pmax.edge becomes 5.5 mm or greater, and the maximum contact pressure is increased to a great value on the contrary. It is found that if the groove depth d is in a range of 2.5 mm to 5.5 mm, as the groove depth d is increased, the maximum contact pressure Pmax.groove in the vicinity of the groove bottom of the annular groove 21 is reduced, a difference between the maximum contact pressure Pmax.edge at the tip end of the annular groove 21 and the maximum contact pressure Pmax.groove in the vicinity of the groove bottom becomes small. That is, the load distribution of the journal bearing is most averaged when the groove depth d is in the range of 2.5 mm to 5.5 mm. Therefore, the bearing end portion does not come into direct contact with the main shaft 5 and their surfaces are not damaged, and the fluid lubrication state can be maintained. Thus, it is possible to realize a journal bearing having low friction coefficient and small slide loss.

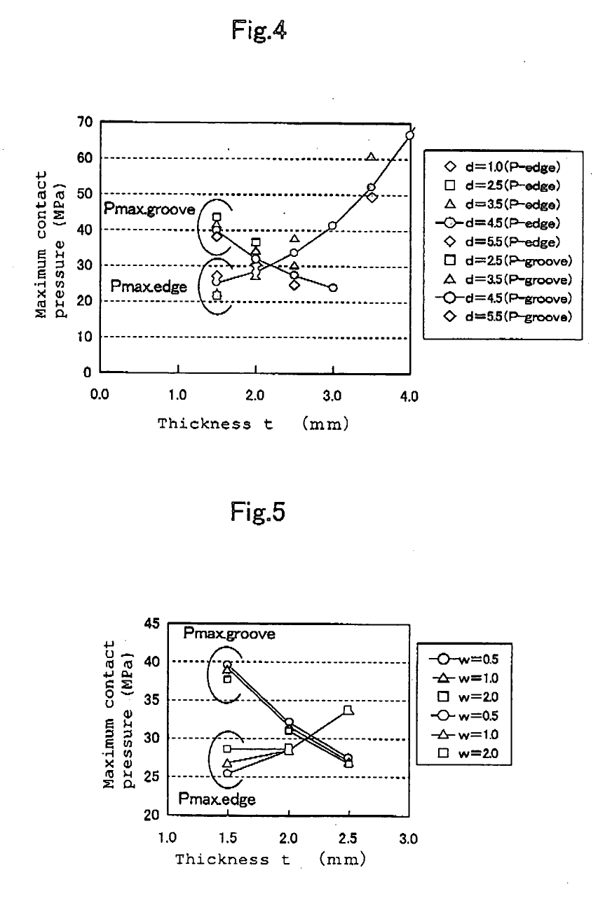

Next, FIG. 4 shows a relation between the thickness t of the annular portion 22 of the annular groove 21 and the maximum contact pressure of the main shaft 5 and the inner surface of the main journal bearing 20. It is found that if the thickness t is increased in a range of 1.5 to 3.0 mm, the maximum contact pressure Pmax.edge at the tip end of the annular groove 21 is abruptly increased, and the maximum contact pressure Pmax.groove in the vicinity of the groove bottom of the annular groove 21 is reduced on the contrary. That is, it is found that a difference between the maximum contact pressure Pmax.edge at the tip end of the annular groove 21 and the maximum contact pressure Pmax.groove in the vicinity of the groove bottom becomes small. Next, if the thickness t is increased and becomes 3.0 mm or more, the difference between the maximum contact pressure Pmax.edge at the tip end of the annular groove 21 and the maximum contact pressure Pmax.groove in the vicinity of the groove bottom is largely increased. Therefore, the load distribution of the journal bearing is most averaged when the thickness t of the annular portion 22 is in the range of 1.5 mm to 3.0 mm. Therefore, the bearing end portion does not come into direct contact with the main shaft 5 and their surfaces are not damaged, and the fluid lubrication state can be maintained. Thus, it is possible to realize a journal bearing having low friction coefficient and small slide loss.

Next, FIG. 5 shows a relation between the thickness t and the maximum contact pressure of the main shaft 5 and the inner surface of the main journal bearing 20 while using the groove width w as a parameter. From this result, it is found that when the groove width w is in a range of 0.5 mm to 2.0 mm, the influence of the groove width w on a value of the maximum contact pressure Pmax.edge at the tip end of the annular groove 21 and the maximum contact pressure Pmax.groove in the vicinity of the groove bottom of the annular groove 21 is small. That is, according to the specification of the groove width w in the above range, since the maximum contact pressure of the main shaft 5 and the inner surface of the main journal bearing 20 is not largely varied, if the groove width w has a value within this range, the bearing end portion does not come into direct contact with the main shaft 5 and their surfaces are not damaged, and the fluid lubrication state can be maintained. Thus, it is possible to realize a journal bearing having low friction coefficient and small slide loss.

Further, influence of the groove width w on the maximum contact pressure is small, influence on the characteristics of the journal bearing is small even if the groove width w of the annular groove 21 is set smaller as compared with the thickness t, and the deformation amount when the tip end of the annular groove 21 is deformed is sufficiently small as compared with the groove width w. Thus, if a slit-like annular groove is formed and its groove width w is set small as compared with the thickness t, the thick portion of the groove is not deformed when the annular groove is formed and the working precision of the thick portion thereof is not deteriorated. Therefore, it is possible to form a precise journal bearing.

Even if the magnitude of the cantilever compression load in the radial direction acting on the main shaft 5 was varied, the same result as the analysis results shown in FIGS. 3 to 5 was obtained.

The present inventors carried out reliability test of a scroll compressor formed with a main journal bearing having an annular groove in the specification range obtained from the analyses (groove depth d=about 5 mm, thickness t of the annular portion 22=about 2 mm and groove width w=1.5 mm), and a scroll compressor formed with a main journal bearing having no annular groove. As a result of the test, the inventors confirmed that under a condition in which abnormal wearing was generated in the main journal bearing having no annular groove, a surface of the main journal bearing having the annular groove in the vicinity of its end was not damaged almost at all.

From the above facts, according to the present embodiment, even if an alternative refrigerant having poor lubricity and a refrigeration oil corresponding thereto are used, it is possible to reduce the slide loss at the journal bearing and to remarkably enhance the efficiency of the compressor without generating wearing and deteriorating the reliability.

Since the bearing is not damaged, there is effect that the reliability of the scroll compressor is remarkably enhanced.

Further, since the surface of the main shaft 5 in the vicinity of an end portion of the journal bearing is subjected to sulphonitriding treatment, even when the operation state is in a transient state and the end portion of the bearing comes into direct contact with the main shaft 5 for a short time, agglutination wear resistance can further be enhanced, and the reliability of the journal bearing can further be enhanced. When the surface of the main shaft 5 is subjected to phosphating treatment such as manganese phosphate treatment, wear resistance of the main shaft 5 can likewise be enhanced.

It is proposed to employ CO₂ refrigerant which is a natural refrigerant having a low warming coefficient for preventing global warming. If the CO₂ refrigerant is used and the compressor is operated in a state in which high-pressure-side pressure exceeds critical pressure, pressure after compression becomes high, and a load applied to each journal bearing becomes extremely great. Therefore, the sliding condition of the journal bearing becomes more severe. However, if the journal bearing for the compressor of this embodiment is employed, it is possible to enhance the wear resistance, and high reliability can be obtained. When polyalkylene glycol oil (PAG oil) having solvency with respect to CO₂ refrigerant is used as a refrigeration oil to secure oil return performance, viscosity of the refrigeration oil is lowered, the sliding condition of the journal bearing becomes more severe. However, if the journal bearing for the compressor of this embodiment is employed, the same effect can be obtained.

### Second Embodiment

A second embodiment of the present invention will be explained with reference to the drawings.

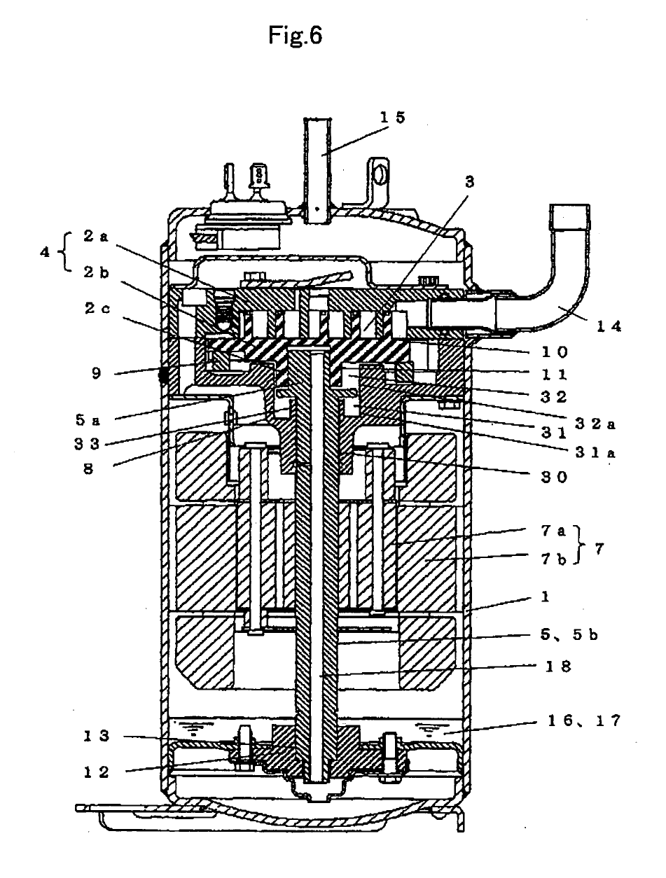

FIG. 6 is a vertical sectional view of a scroll compressor according to the second embodiment of the invention. The scroll compressor shown in FIG. 6 has the same structure as that of the conventional scroll compressor explained based on FIG. 7 except the journal bearing portion. Therefore, the same function parts are designated with the same numerals and explanation thereof is partially omitted.

The second embodiment is different from the first embodiment in that a groove width w of an annular groove 31 provided in an end of a main journal bearing 30 that is opposite from the motor 7 is increased, and an outer peripheral surface 31a of the annular groove 31 and an inner peripheral surface 32a of a recess 32 provided in an upper end of the main housing 8 are the same surface. An annular groove depth d and the thickness t of an annular portion 33 are the same as those of the first embodiment. That is, the annular groove depth d is 2.5 mm to 5.5 mm, and the thickness t of the annular portion 33 is 1.5 mm to 3.0 mm. Influence of the groove width w on contact pressure of the journal bearing surface provided with the annular groove is small as described above with reference to FIG. 5. Therefore, even if the groove width w is increased, the same effect of the annular groove as that of the first embodiment can be obtained.

That is, in this embodiment, the thin annular portion 33 is provided on the upper end of the main journal bearing 30 where a bearing distance between the main shaft 5 and the inner surface of the bearing becomes extremely small (or they come into direct contact with each other). Therefore, the rigidity of the end of the journal bearing end is lowered. Therefore, if a moment is applied to the main shaft 5 and the main shaft 5 is inclined in the bearing and the load distribution is increased at the bearing end, the inner surface of the bearing end is deformed, and the contact stress of the main shaft 5 and the inner surface of the bearing can be reduced. Thus, the bearing end portion does not come into direct contact with the main shaft 5 and their surfaces are not damaged, and fluid lubrication state can be maintained. Thus, it is possible to realize a journal bearing having low friction coefficient and small slide loss.

In this embodiment, it is unnecessary to form a deep groove having narrow groove width unlike the first embodiment and thus, the working is easy, and it is possible to realize a reliable journal bearing with low cost.

From the above reasons, according to this embodiment, the reliability is not deteriorated by wearing, and it is possible to reduce the slide loss of the journal bearing, and to remarkably enhance the efficiency of the compressor.

Since the bearing is not damaged, there is effect that the reliability of the scroll compressor is remarkably enhanced.

Although the first and second embodiments explained the main journal bearing, even if the present invention is applied to the auxiliary journal bearing and the eccentric journal bearing, the slide loss of the journal bearing can be reduced and the wear resistance is enhanced. The same effect can be obtained even if the present invention is applied to journal bearings of other types such as a rotary compressor and a reciprocating compressor.

In the embodiments, the diameter of the main shaft is 16 mm, the annular groove depth is 2.5 mm to 5.5 mm (ratio of 0.15 to 0.34), and the thickness of the annular portion is 1.5 mm to 3.0 mm (ratio of 0.09 to 0.19). It is preferable that not only the main shaft diameter, but also other ratios are within the above-described ranges.

### INDUSTRIAL APPLICABILITY

According to the scroll compressor of the present invention, as described above, even when the main shaft is bent and deformed or inclined by a radial force of a compression load, wearing and surface damage are not generated by the direct contact of the journal bearing of the compressor, slide loss can be reduced, and a scroll compressor having a reliable and efficient structure can be provided.

1. A scroll compressor comprising a compression mechanism, a main shaft for driving said compression mechanism, a motor for rotating said main shaft, and a journal bearing for supporting said main shaft, wherein said journal bearing is provided at its end with an annular groove, thereby forming an annular portion on an inner peripheral side of said annular groove, a ratio of a groove depth of said annular groove to a diameter of said main shaft is in a range of 0.15 to 0.34, and a ratio of a thickness of said annular portion to the diameter of said main shaft is in a range of 0.09 to 0.19.

2. The scroll compressor according to claim 1, wherein an outer peripheral surface of said annular groove is an inner peripheral surface of a recess formed in a main housing formed with said journal bearing.

3. The scroll compressor according to claim 1, wherein a surface of the main shaft in the vicinity of an end portion of the journal bearing is subjected to conversion treatment including at least sulphonitriding treatment or phosphating treatment.

4. The scroll compressor according to claim 1, wherein carbon dioxide refrigerant is used as working fluid to be compressed by said compression mechanism, polyalkylene glycol (PAG) oil is used as refrigeration oil for lubricating said compression mechanism and said journal bearing.
